(19) United States
(12) Patent Application Publication
(10) Pub. No.: US 2012/0008751 A1
(43) Pub. Date: Jan. 12, 2012

(54) Home star security system

(76) Inventor: James Forbes, Phoenix, AZ (US)

(21) Appl. No.: 13/135,404

(22) Filed: Jul. 5, 2011

Related U.S. Application Data
(60) Provisional application No. 61/398,982, filed on Jul. 2, 2010.

(51) Int. Cl. H04M 11/04; G10L 21/00

(52) U.S. Cl. 379/44; 704/270; 704/E21.001

(57) ABSTRACT

The Home Star is an interactive security and communication system for the home which is wired to doors, windows and other points of entrance, with infrared motion sensors included to detect home invaders. Once tripped, this alarm sends a silent signal to the authorities and the Home Star command center, ensuring that police back up and support is immediately directed to the location. More than a mere security system, the Home Star provides a complete communication system for the home enabling occupants to place and receive telephone calls, print documents and road maps and access other family members, all with a simple press of the activation switch. This in turn activates an interactive system of voice prompts which enables the user to execute any number of function specific commands.

### CLAIM OF PRIORITY

This patent application claims priority under 35 USC 119 (e) (1) from U.S. Provisional Patent Application Ser. No. 61/398,982 filed Jul. 2, 2010, of common inventorship herewith entitled, “HOME STAR.”

### FIELD OF THE INVENTION

The present invention pertains to the field of home security devices, and more specifically to the field of automated home security monitoring devices.

### BACKGROUND OF THE INVENTION

The prior art has put forth several designs for automated home security monitoring devices. Among these are:

U.S. Pat. No. 6,731,208 to Hsin Wu Lee describes a house intercom security system which includes a main unit connected between the exchange line of a telecommunication office and a telephone set, an indoor intercom and an outdoor intercom respectively connected to the main unit, and an alarm connected to the main unit.

U.S. Pat. No. 5,598,456 to David H. Feinberg describes an integrated telephone, intercom, security and control system for a building having a plurality of units, utilizing a plurality of telephone lines located throughout the building which are connected at one end to telecommunications equipment located in the units and throughout common area of the building.

U.S. Pat. No. 7,123,142 to Lucien Bohbot and Andrei Doilidov describes an integrated intercom and security system including a local integrated intercom and security system and a remote communication in communication with the local intercom and security system via a global accessible communication network.

None of these prior art references describe the present invention.

### SUMMARY OF THE INVENTION

It is an object of the present invention to provide an improved automated home security monitoring device.

### BRIEF DESCRIPTION OF THE DRAWINGS

FIG. 1 is a close-up right-angled perspective view of the control panel, a portion of the device of the present invention.

FIG. 2 is a negative elevational close-up perspective view of the speaker, another portion of the device of the present invention.

FIG. 3 is a negative elevational angled perspective view of the device of the present invention.

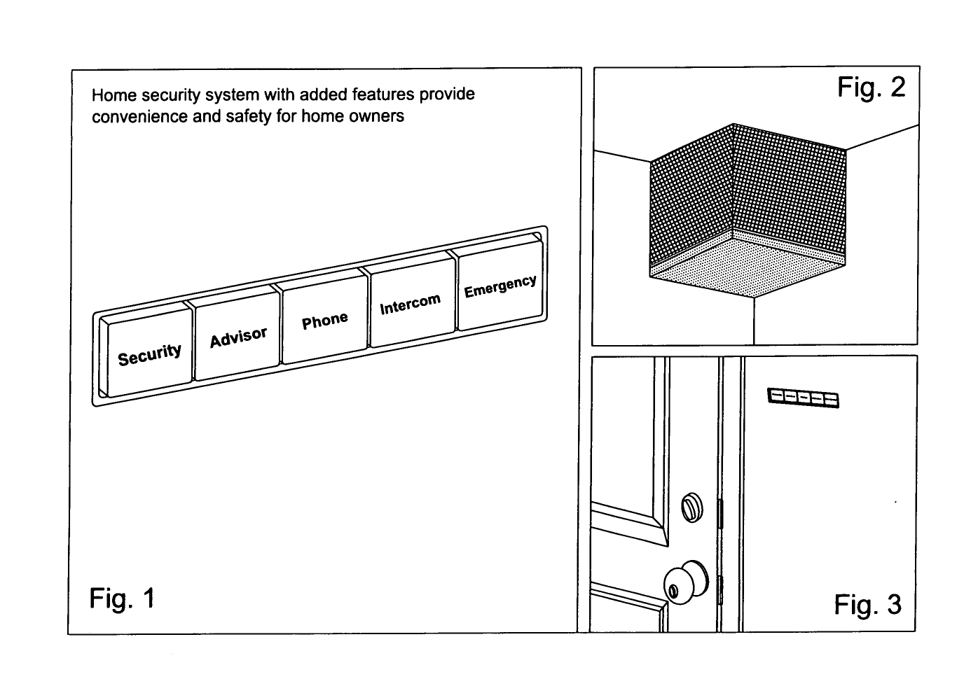

### DETAILED DESCRIPTION OF THE INVENTION

Of the most feared personal crimes, the home invasion is at the top of the list. The frightening thing is that it is motivated by a variety of criminal intentions, most usually robbery. It is not uncommon for invaders to suddenly pull a weapon and burglarize a victim on the spot after impersonating a repairman, a delivery boy, salesman, policeman, or an individual in the need of a Good Samaritan. In a worst case scenario the intention is rape, kidnapping, torture, or terrorism. In these situations, an armed invader takes the victim by surprise simply by kicking in the door or bursting through a window. Sometimes the invasion is motivated by the desire to procure normally private information such as a credit card or bank account number that is later sold or used for fraudulent purposes. In addition, a person may invade one's home for the purposes of preparing for a future robbery by assessing belongings and the vulnerability of entry points.

Regardless of the motivation, concerned citizens are eager to implement extra security measures to prevent becoming a victim of such an invasive, frightening crime.

The present invention, hereinafter referred as the Home Star, offers a convenient solution to the aforementioned challenges. The Home Star is an interactive security and communication system for the home, modeled after the OnStar® communication system installed in motor vehicles.

As a security system, the Home Star is wired to doors, windows and other points of entrance, with infrared motion sensors included to detect home invaders. Once tripped, this alarm sends a silent signal to the authorities and the Home Star command center, ensuring that police back up and support is immediately directed to the location. More than a mere security system, the Home Star provides a complete communication system for the home enabling occupants to place and receive telephone calls, print documents and road maps and access other family members, all with a simple press of the activation switch. This in turn activates an interactive system of voice prompts which enables the user to execute any number of function specific commands.

The Home Star is comprised of a home or office phone system with mini microphones that are placed throughout the home/apartment or office in addition to speakers. A button is placed at two or three points.
1. Main entrance of home or office
2. Master bedroom
3. Garage door entrance

Upon entering the home or office one pushes such button to turn on/off the microphones and speakers, once this is done he or she makes and receives phone calls. A voice comes across the surround sound speakers asking for the number of which you want to call. Once the number is given the voice prompt asks if the user wants the number dialed. When the call is dialed and the number goes through the user has a conversation truly hands free, walking throughout their home or office.

Home Star is able to tie into a home or office security system, tie into the Internet, etc. Home Star provides navigation to the homeowner prior to the homeowner leaving their dwelling. The information of directions is sent via e-mail, allowing the user to download and print the directions from a home computer, a method not presently available with traditional telephone operators.

Security: Home Star helps drop the crime rate of home invasions, in addition to actually saving lives from invasions and break-ins. With such an alarm system in a home, an intruder never knows that everything is being heard and that help is on the way, and will be caught in the act. Furthermore, with Home Star, one monitors their home from virtually anywhere in the world.

The Home Star is a practical product invention which offers consumers a number of significant benefits and advantages. Foremost, this unique alarm and communication system provides homeowners with a simple and effective means of preventing a home invasion. Offering enhanced alarm reinforcement via interactive, satellite technology, this cleverly designed device sufficiently strengthens an entryway into the home. In this manner, even if a homeowner is fooled into cracking open a door for a visitor with nefarious intentions, the Home Star alarm sounds, alerts authorities and foils any invader in his tracks. Elderly homeowners, especially, appreciate the security afforded by this practical product. As they are more susceptible to attack from a younger, stronger assailant, seniors more effectively defend their homes with installation of the Home Star. More than a security system, the Home Star provides consumers an innovative communication tool, allowing family members to communicate with others who are in different rooms of a home, or outside the home altogether. Featuring an interactive system which understands a myriad of voice commands, the Home Star enables the user to carry on telephone conversations, access important information and road directions, or simply send a voice greeting to a friend in another country, all with the touch of a button. Fashioned from durable, high quality materials and components, this product withstands years of continued use.

The Home Star is an innovative product that readily enhances home security and communication the world over.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An automated home security monitoring device, comprising an interactive security and communication system for the home, wherein the system is wired to doors, windows and other points of entrance, with infrared motion sensors included to detect home invaders, wherein the device sends a silent signal to the authorities and the Home Star command center, ensuring that police back up and support is immediately directed to the location when the device is triggered.

2. A communication system for the home enabling occupants to place and receive telephone calls, print documents and road maps and access other family members, all with a simple press of the activation switch, including an interactive system of voice prompts which enables the user to execute any number of function specific commands.

3. The system of claim 1 further comprising a home or office phone system with mini microphones that are placed throughout the home/apartment or office in addition to speakers, wherein a button is positioned at two or three points.

4. The device of claim 3 wherein the positions of the buttons include main entrance of home or office, master bedroom, garage door entrance.
